(19) United States
(12) Patent Application Publication
(10) Pub. No.: US 2007/0244914 A1
(43) Pub. Date: Oct. 18, 2007

(54) Electronic information feedback

(76) Inventor: Barrett Morris Kreiner, Woodstock, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/405,305

(22) Filed: Apr. 17, 2006

(51) Int. Cl. G06F 7/00

(52) U.S. Cl. 707/101

(57) ABSTRACT

Included are systems and methods for providing customization via information feedback. At least an embodiment of a method includes providing data related to a web page and receiving data related to at least one user action on the web page, the at least one user action being indicative of user interest related to at least one item displayed on the web page. Other embodiments include determining a category related to the at least one item and sending data related to at least one other item, the at least one other item being related to the determined category.

### BACKGROUND

As Internet usage has become more common, Internet patrons have become more demanding of the websites they visit. While Internet patrons once were satisfied with static web pages that provide only textual information, now websites are expected to provide much more. In response to user demand and technological advances, websites began providing online merchant sites, as well as other web environments to provide users with large amounts of data. As many of these websites are funded via user purchases and/or advertisements, there may be an incentive to expose users to predetermined areas of the website. Additionally, if a website offers merchandise (and/or services) for sale, it may be desirable that the website present the user with data related to the needs and/or desires of that particular user, based on user actions.

Thus, a heretofore unaddressed need exists in the industry to address the aforementioned deficiencies and inadequacies.

### SUMMARY

Included methods for providing customization via information feedback. At least an embodiment of a method includes providing data related to a web page and receiving data related to at least one user action on the web page, the at least one user action being indicative of user interest related to at least one item displayed on the web page. Other embodiments include determining a category related to the at least one item and sending data related to at least one other item, the at least one other item being related to the determined category.

Additionally included are embodiments of a computer readable medium for providing customization via information feedback. At least an embodiment of a computer readable medium includes logic configured to provide data related to a web page and logic configured to receive data related to at least one user action on the web page, the at least one user action being indicative of user interest related to at least one item displayed on the web page. Other embodiments include logic configured to determine a category related to the at least one item and logic configured to send data related to at least one other item, the at least one other item being related to the determined category.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

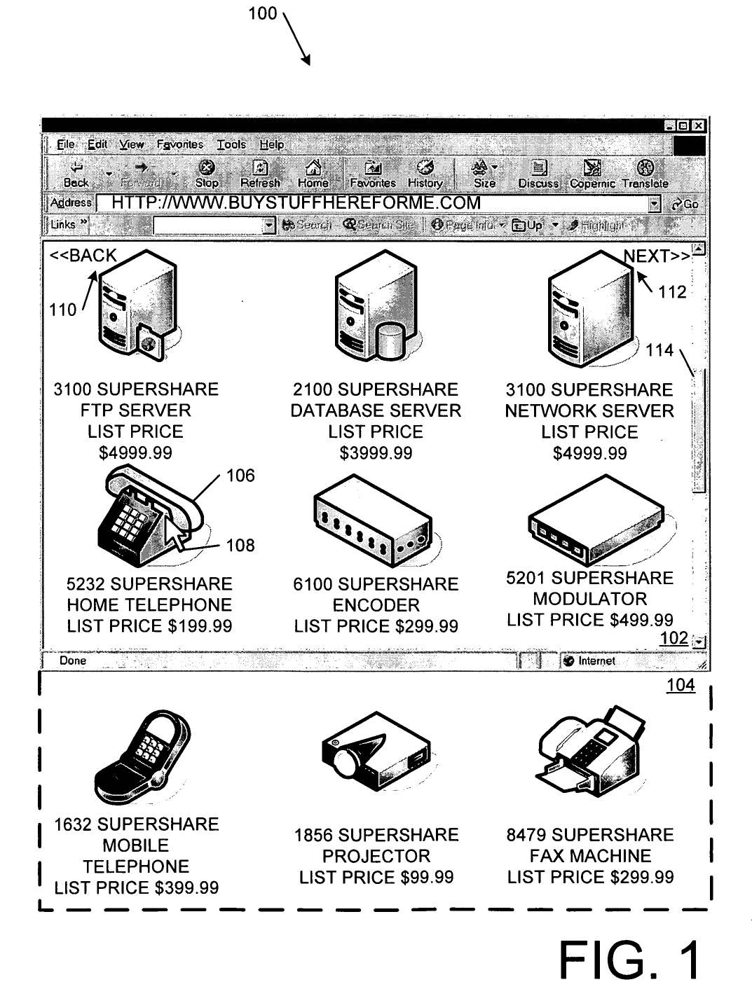

FIG. 1 illustrates an exemplary embodiment of a user interface that is configured to display data related to a website.

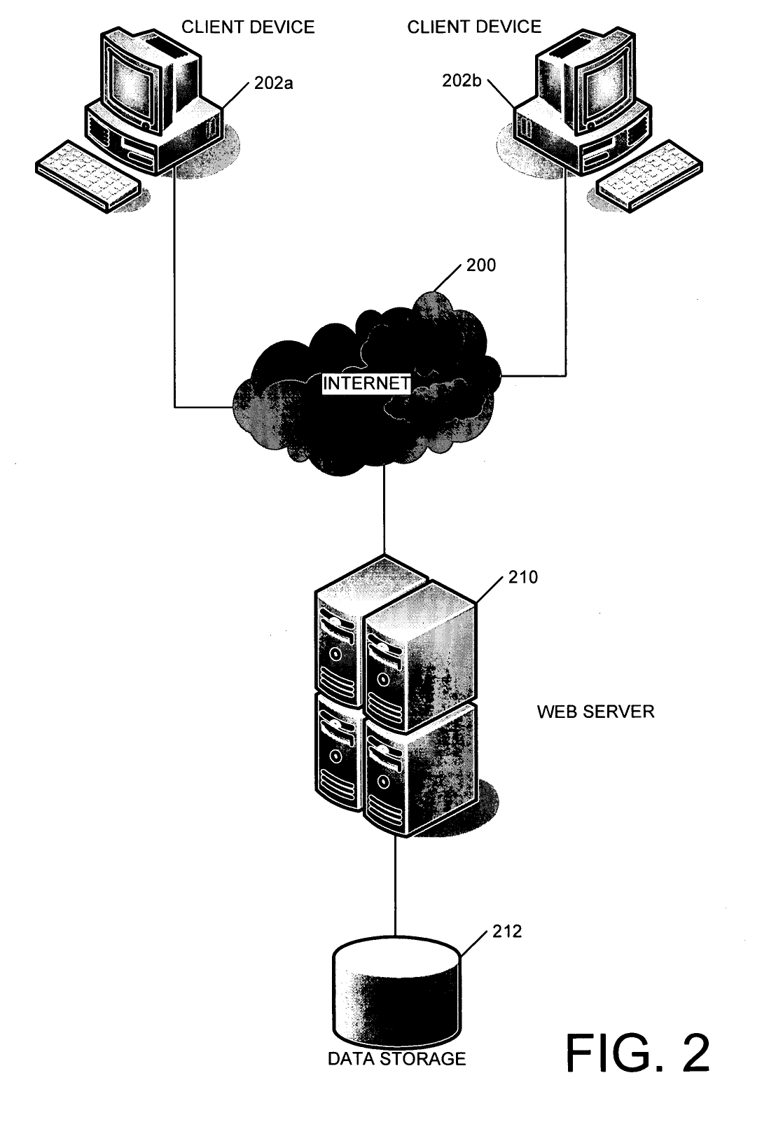

FIG. 2 illustrates a network configuration for communicating website data, such as the data from FIG. 1, according to an exemplary embodiment.

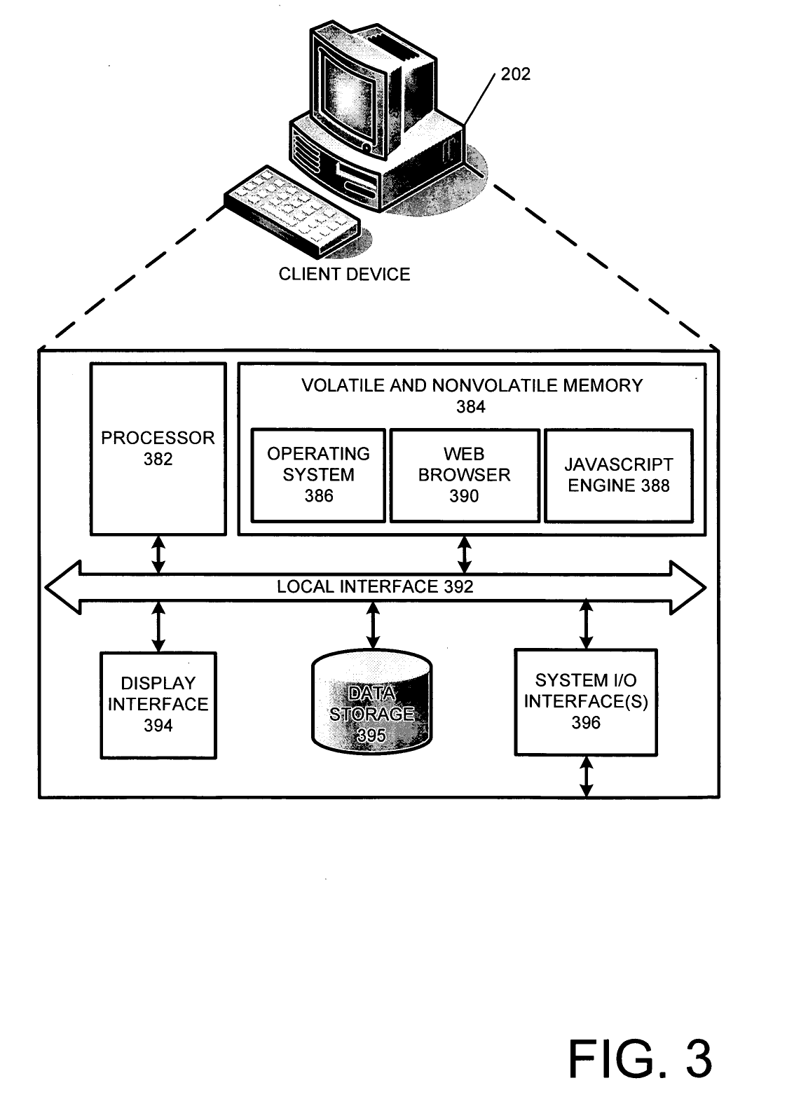

FIG. 3 is a block diagram illustrating various components that may be present in a client device, such as the client device from FIG. 2, according to an exemplary embodiment.

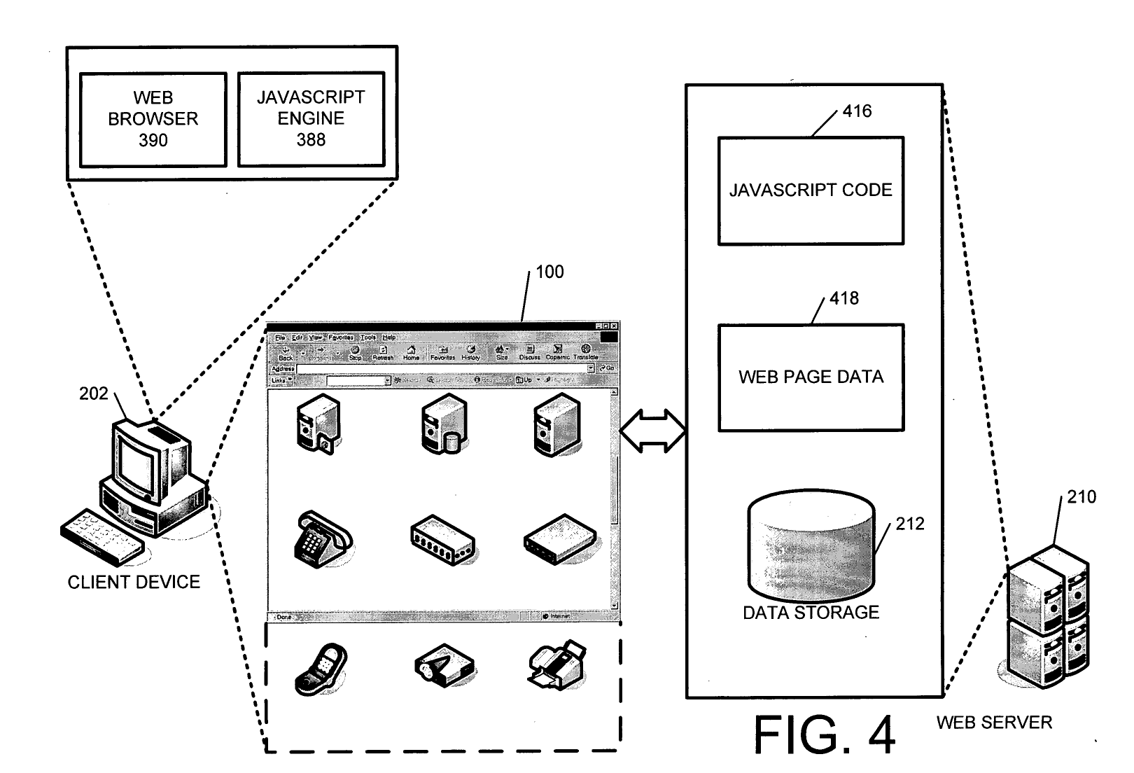

FIG. 4 is a diagram illustrating various components that can be utilized for communicating data to an application server, according to an exemplary embodiment.

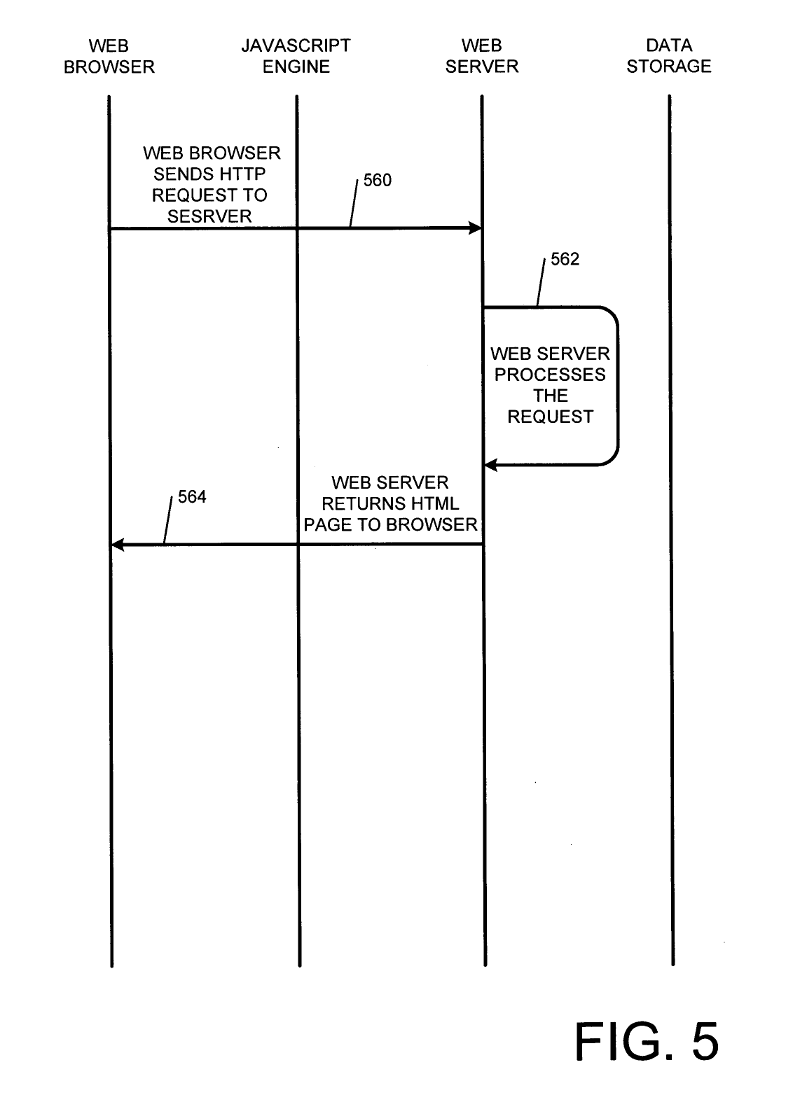

FIG. 5 is a sequence diagram illustrating an exemplary embodiment of steps that may be taken in synchronously communicating data between a web server and a web browser, such as the web browser in FIG. 4.

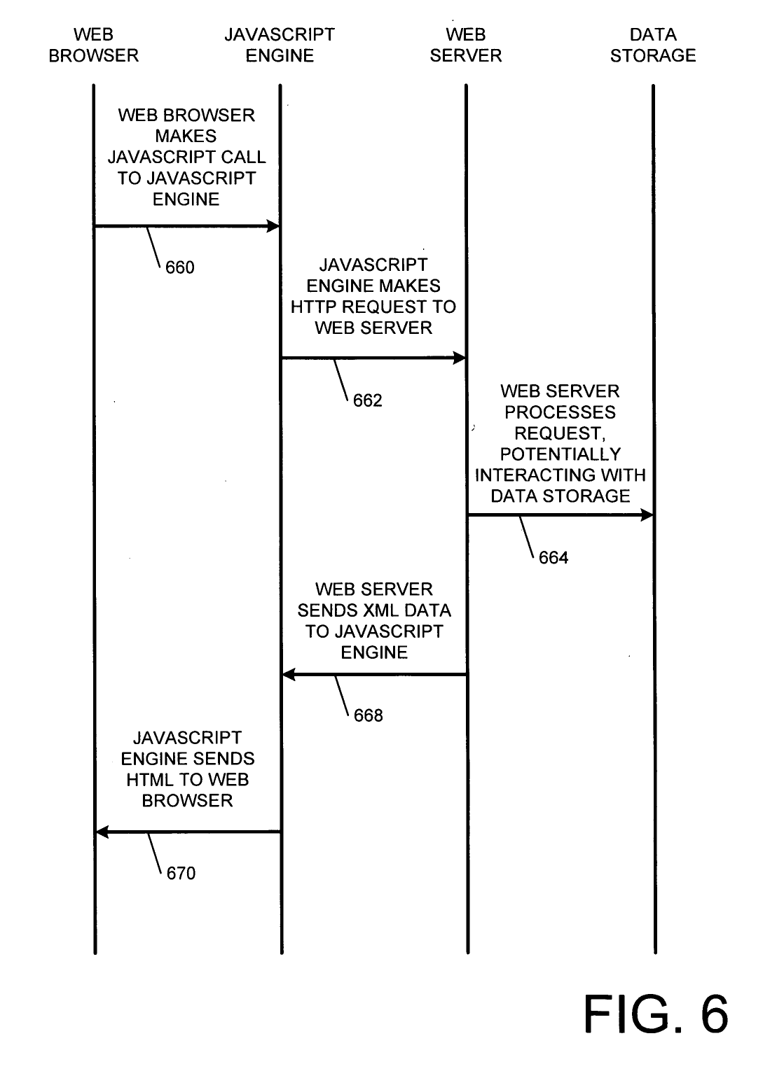

FIG. 6 is a sequence diagram illustrating an exemplary embodiment of steps that may be taken in asynchronously communicating data between a web server and a web browser, similar to the sequence diagram from FIG. 5.

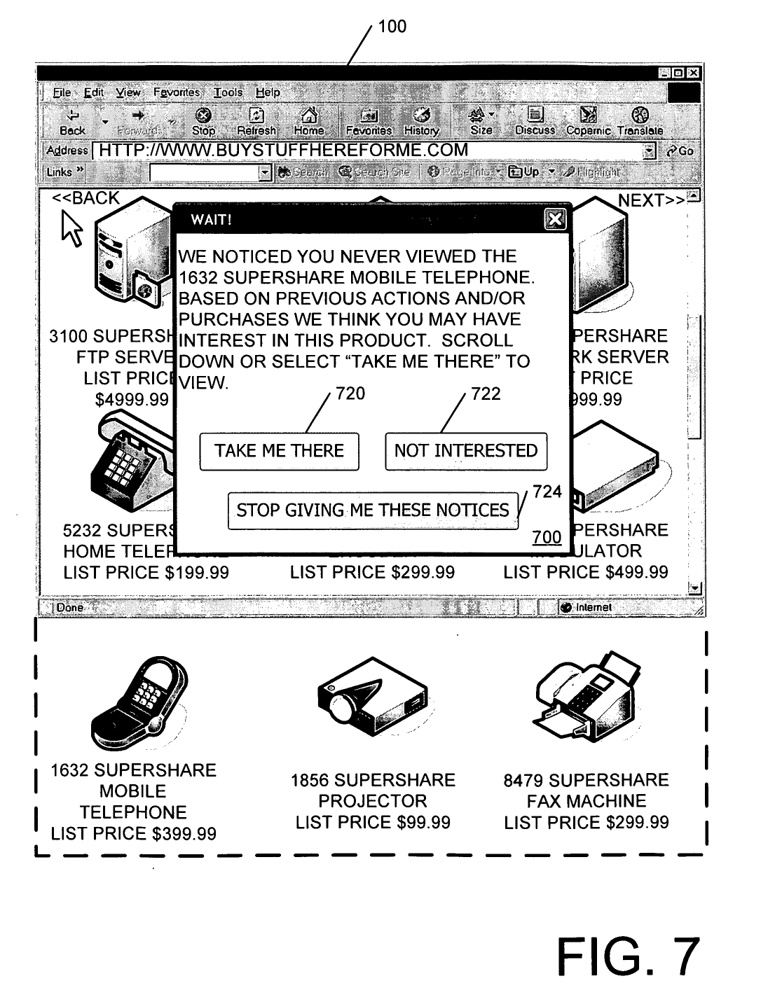

FIG. 7 illustrates a user interface illustrating for providing data to users, based on user actions, similar to the configuration from FIG. 1, according to an exemplary embodiment.

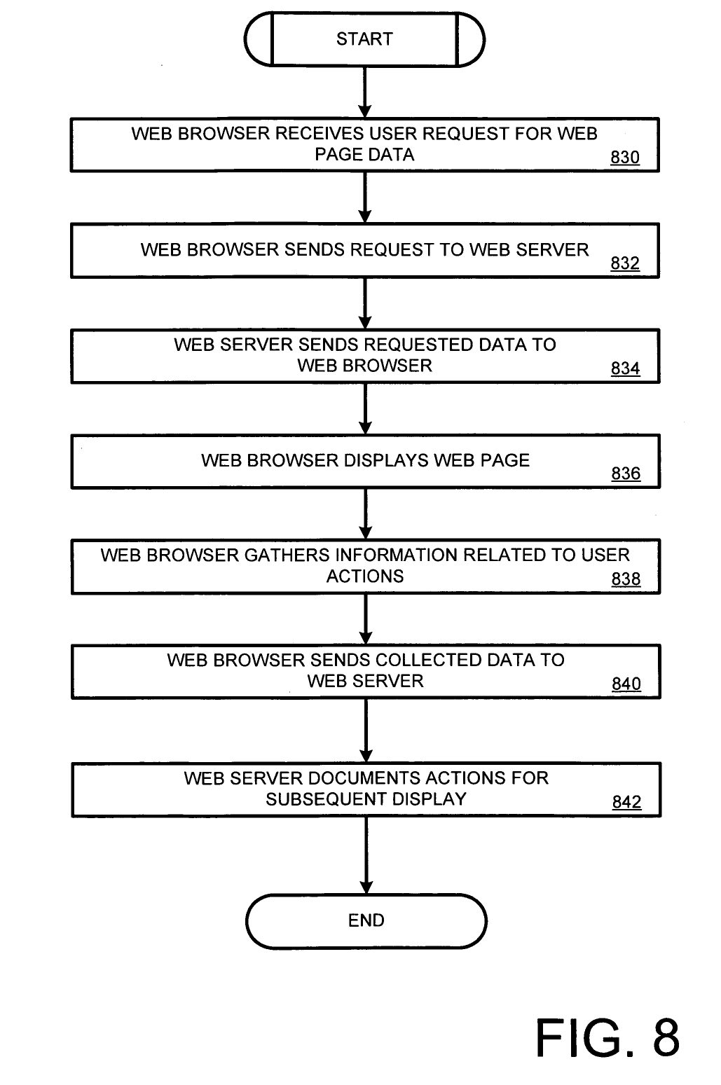

FIG. 8 is a flowchart illustrating an exemplary embodiment of steps that can be taken in synchronously communicating data between a web server and a web browser, similar to the sequence diagram from FIG. 5.

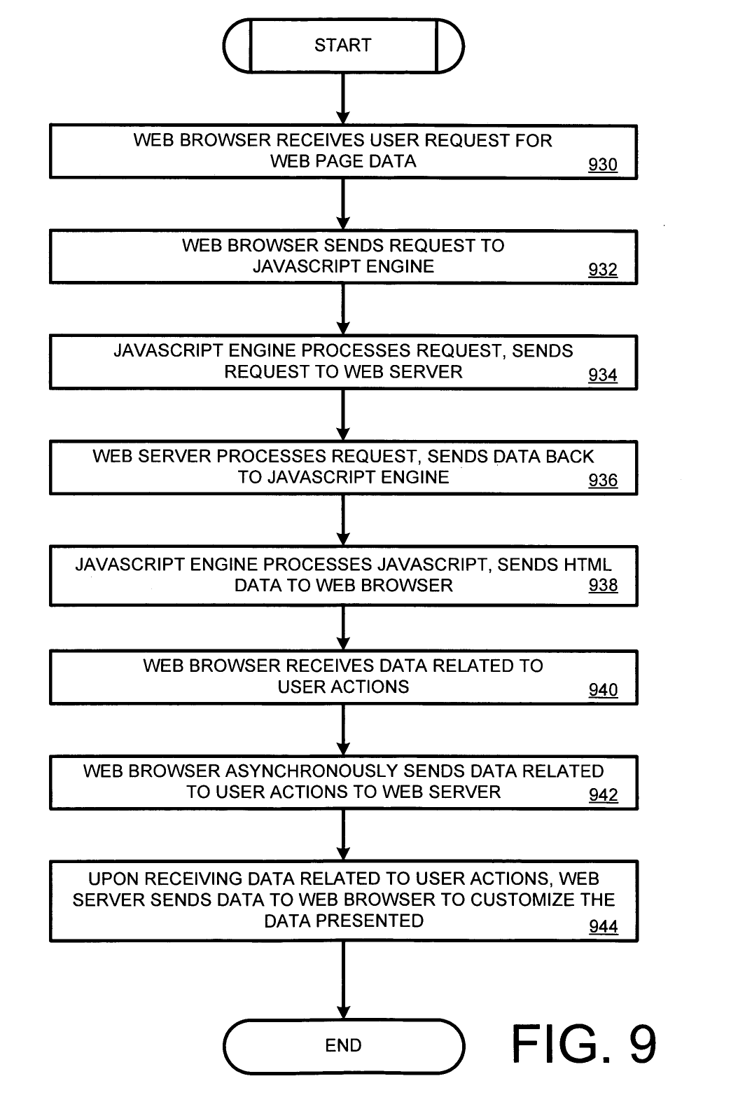

FIG. 9 is a flowchart illustrating an exemplary embodiment of steps that can be taken in asynchronously communicating data between a web server and a web browser, similar to the flowchart from FIG. 8.

### DETAILED DESCRIPTION

FIG. 1 illustrates a user interface that is configured to display data related to a website, according to an exemplary embodiment. As illustrated, user interface 100 (which may be provided by a web browser) can be configured to display any of a plurality of data, including, for example, items listed on www.buystuffhereforme.com. The user interface shown in FIG. 1 may be accessed by inputting a Uniform Resource Locator (URL) into an address prompt (or otherwise making a request to view a web page), causing a web browser to send a request to a web server associated with the URL. In response to receiving the request from the web browser, the web server can send data (such as Hypertext Markup Language (HTML) data) that the browser can utilize for displaying the web page in user interface 100. The web page shown in FIG. 1 includes two portions: a visible portion 102 and a nonvisible portion 104. According to one embodiment, the visible portion 102 of the web page displays a plurality of items for sale, including the 5232 Supershare home telephone 106, as well as a back link 110 and a next link 112. In this nonlimiting example, a user has hovered a mouse cursor 108 over item 106.

Also included in the nonlimiting example of FIG. 1 is a nonvisible portion 104 of the web page. In the nonvisible portion 104, additional items may be displayed, which the user can view by scrolling down the page using bar 114. If the user desires not to scroll down or is otherwise unaware of the presence of items in the nonvisible portion 104 of the web page, the user may never be presented with data that may be potentially relevant to the needs and/or desires of that particular user.

While the desired information may be available to the user in this scenario, due to the amount of data present, the time the user can spend on any one item and/or other factors, the user may not actually see the desired data (or product), which may be displayed in the nonvisible portion 104 of the web page. Similarly, even if the user actually scrolls down to view the nonvisible portion 104, the desired data may nevertheless be missed. As such, the user may assume the desired data is unavailable, and thus search elsewhere.

FIG. 2 illustrates an exemplary embodiment of a network configuration for communicating website data, such as the data from FIG. 1. As illustrated, client devices 202a and 202b are coupled to a network, such as the Internet 200. Also coupled to the Internet 200 is a web server 210, which may be coupled to data storage 212. In operation, a user operating client device 202 can send a request for a web page. The request can be sent from a web browser at a client via the Internet, to a web server 210 associated with the requested web page. The web server can process the request (potentially accessing data storage 212), and send data related to the requested web page back to the client device 202 via the Internet. The client device 202 can receive the data, process the data, and render a display for the received data. The display can take the form of a web page, but this is not a requirement. Additionally, as discussed in more detail below, the user may interact with the web server 210 via the user interface 100. The interaction between the user and web server 210 can include communication of data either synchronously or asynchronously (e.g., passive user actions). When data is being communicated synchronously from the user to the web server 210, various data related to user actions can be sent to the web server 210 during (and/or time proximate to) a send event. Asynchronous communication of data from the user, as discussed in more detail below can utilize Asynchronous JavaScript and XML (AJAX) and/or other technologies for communicating data to a web server (or other web page provider) independent of a send event.

FIG. 3 is a block diagram illustrating various components that may be present in a client device, such as the client device from FIG. 2, according to an exemplary embodiment. Although the client device of FIG. 3 is illustrated as a personal computer, this discussion can be applied to any device that can be configured for providing the desired functionality. Examples include, but are not limited to a desktop computer, laptop computer, mobile telephone, Blackberry®, PDA, Ipod®, Treo®, etc. Generally, in terms of hardware architecture, as shown in FIG. 3, the client device 202 includes a processor 382, volatile and nonvolatile memory 384, a display interface 394, data storage 390, and one or more input and/or output (I/O) device interface(s) 396 that are communicatively coupled via a local interface 392. The local interface 392 can include one and/or more buses or other wired or wireless connections. The local interface 392 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 382 may be a hardware device for executing software, particularly software stored in volatile and nonvolatile memory 384.

The processor 382 can be any custom made or commercially available processor, a central processing unit (CPU), an auxiliary processor among several processors associated with the client device 202, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80×86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 384 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 384 may incorporate electronic, magnetic, optical, and/or other types of storage media. Note that the volatile and nonvolatile memory 384 can have a distributed architecture, where various components are situated remote from one another, but can be accessed by the processor 382. Additionally, volatile and nonvolatile memory 384 can include an operating system 386, a web browser 390, and a JavaScript engine 388. As one of ordinary skill in the art will understand, while the operating system 386, web browser 390, and JavaScript engine 388 are illustrated as separate software components within the same memory unit 384, this is a nonlimiting example. More specifically, depending on the particular configuration, these software components may be combined either in whole or in part. Similarly, while client device 202 is illustrated as including an operating system 386 a web browser 390, and a JavaScript engine 388, one should note that, depending on the particular configuration, client device 202 may include only a portion of these components and/or functionality. Additionally, while these components are illustrated as software modules, as one of ordinary skill in the art will understand, this logic can be represented in one or more components of software, hardware, firmware, etc.

Additionally, the operating system 386 in volatile and nonvolatile memory 384 may include one or more separate programs, each of which includes an ordered listing of executable instructions for implementing logical functions. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; and/or (g) an appliance-based operating system, such as that implemented in handheld computers or personal data assistants (PDAs) (e.g., PalmOS® available from Palm® Computing, Inc., and Windows CE® available from Microsoft® Corporation). The operating system 386 can be configured to control the execution of other computer programs and provides scheduling, input-output control, file and data management, memory management, and communication control and related services.

A system component embodied as software may also be construed as a source program, executable program (object code), script, and/or any other entity comprising a set of instructions to be performed. When constructed as a source program, the program is translated via a compiler, assembler, interpreter, or the like, which may or may not be included within the volatile and nonvolatile memory 384, so as to operate properly in connection with the Operating System 386.

The Input/Output devices that may be coupled to system I/O Interface(s) 396 may include input devices, for example but not limited to, a keyboard, mouse, scanner, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 202 is a personal computer, workstation, or the like, the software in the volatile and nonvolatile memory 384 may further include a basic input output system (BIOS) (omitted for simplicity). The BIOS is a set of software routines that initialize and test hardware at startup, start the Operating System 386, and support the transfer of data among the hardware devices. The BIOS is stored in ROM so that the BIOS can be executed when the client device 202 is activated.

When the client device 202 is in operation, the processor 382 may be configured to execute software stored within the volatile and nonvolatile memory 384, to communicate data to and from the volatile and nonvolatile memory 384, and to generally control operations of the client device 202 pursuant to the software. Software in memory, in whole or in part, are read by the processor 382, perhaps buffered within the processor 382, and then executed.

FIG. 4 is a diagram illustrating various components that can be utilized for communicating data to an application server, according to an exemplary embodiment. As illustrated in this nonlimiting example, client device 202 can be configured with a JavaScript engine 388 and a web browser 390 (FIG. 3) for displaying user interface 100. The JavaScript engine 388 may be included in the web browser logic, but this is not a requirement. The web server 210 can be configured with (and/or coupled to) JavaScript code 416 and web page data 418 associated with one or more websites. The web server 210 can also be configured with and/or coupled to data storage 212.

In at least an embodiment, the web browser 390 can be configured to request a web page related to a web server. As discussed above, while the request can be made by sending a data to a web server, other methods are also contemplated. Upon receiving the request, the web server 210 can process the request and send web page data 418 as well as JavaScript code 416 back to the client device 202. The web browser 390 can be configured to receive the web page data 418 and JavaScript code 416 and process the received data (potentially utilizing JavaScript engine 388) for displaying the web page and user interface 100.

Additionally, depending on the particular configuration, the web browser 390 can be configured to collect data related to user actions on one or more website that the user visits. More specifically, the web browser 390 can be configured to document items the user selects, as well as items that the user hovers a cursor over and/or near an item on a web page, places on a web page where the user pauses, items the user highlights, copies, pastes, items the user positions in the visible portion of a web page, etc. The web browser 390 may also be coupled to biometric input components that may be configured for authentication and/or facilitating data collection for web browser 390. More specifically, in at least an embodiment, a biometric component may be configured to determine eye position, pupil dilation, pulse, blood pressure, body temperature, etc. for determining data (e.g., products and/or services) that the user may have an interest in.

Upon collecting any of a plurality of different data associated with user actions, the web browser 390 and/or JavaScript engine 388 can facilitate communication of the collected data to the web server 210. Communication of the collected data can include synchronous communication of data, however this is a nonlimiting example. In at least an embodiment, the browser can be configured to send data to the web server asynchronously, such as via Asynchronous JavaScript and XML (AJAX) technologies, as described in more detail below.

Additionally, while the above description relates to sending collected data to a web server 210 associated with the currently viewed website, this is also a nonlimiting example. In at least an embodiment, the web browser can be configured to send collected data to a third party web server (or other computing device) that can be configured for collecting and/or analyzing data related to user actions on websites. The third party web server 210 can then establish business arrangements with other website providers for customizing the user's website experience.

FIG. 5 is a sequence diagram illustrating an exemplary embodiment of steps that may be taken in synchronously communicating data between a web server and a web browser, such as the web browser in FIG. 4. The first step in the nonlimiting example of FIG. 5 is for the web browser 390 to send a Hypertext Transfer Protocol (HTTP) request to the web server 210 (step 560). The request can include data related to the desired web page and include a URL or other identifier of the desired data. Upon receiving the request, the web server 210 can process the request (step 562). Although not shown, the web server may be configured to process the request by communicating with data storage 212. Upon processing the request, the web server 210 can return HTML data to the web browser 390 for display on client device 202 (step 564).

As discussed in more detail below, the synchronous exchange of data between the web browser 390 and the web server 210 can involve waiting for data to be received before sending data. More specifically, in at least an embodiment, the web server 210 waits for a request before processing can begin. While the web server 210 is processing the request, the web browser 390 is waiting for the requested data. As such, with reference to the collection and communication of data related to user actions, in a synchronous configuration, the web browser 390 can be configured to collect data related to user actions. The web browser 390 can also be configured to store (and/or facilitate storage) of the data until the occurrence of a send event. A send event can include any action where the user makes a submission and/or request to the web server 210. When a send event occurs, the web browser 390 can include at least a portion of the collected data with the submission and/or request.

As a nonlimiting example, referring back to FIG. 1, upon receiving the web page, the user has hovered the mouse cursor over the 5232 Supershare home telephone 106. The web browser 390 can document this user action for purposes of determining that the user is potentially interested in a category of product that includes a telephone. While viewing the web page of FIG. 1, the user may not create a send event, so the web browser 390 may store data related to this user action until such event occurs. Upon selection of one of the items in the web page of FIG. 1 (and/or other send event), the web browser 390 can generate the desired request to the web server 210 and send the request as well as the collected user action data to the web server 210.

FIG. 6 is a sequence diagram illustrating an embodiment of steps that may be taken in asynchronously communicating data between a web server and a web browser, similar to the sequence diagram from FIG. 5. The first step in this nonlimiting example is for the web browser 390 to make a JavaScript call to the JavaScript engine 388 (step 660). The JavaScript engine can then make an HTTP request to the web server 210 (step 662). The web server 210 can then process the request, potentially interacting with data storage 212 (step 664). Upon processing the request, the web server 210 can send Extensible Markup Language (XML) data to the JavaScript engine 388 (step 688). The JavaScript engine can then process the data and send HTML data to the web browser 390 (step 670).

More specifically, instead of loading a web page at the start of the session, the web browser 390 can be configured to load the JavaScript engine 388, which can be tucked away in a hidden frame. The JavaScript engine 388 can be responsible for both rendering the user interface 100 and communicating with the web server 210. The JavaScript engine 388 can be configured to allow the user's actions to be communicated with the web server 210 to occur asynchronously. Thus, actions such as hovering a mouse cursor over a certain area of the web page are sent to the web server 210 independent from communication of send events.

FIG. 7 illustrates an exemplary user for providing data to users, based on user actions, similar to the configuration from FIG. 1. As illustrated, user interface 100 is displaying the www.buystuffhereforme.com web page. Referring back to FIG. 1, the user has hovered the mouse cursor over the 5232 Supershare home telephone 106. Additionally, the user has not scrolled down to view the 1632 Supershare Mobile telephone. Upon receiving this passive information (and/or other information), the web browser 390 can collect and/or facilitate communication (e.g., via JavaScript engine) of this action to the web server 210. As the user appears to be interested in a category of products that includes telephones, upon selecting the back link 110 (and/or upon detecting mouse cursor motion to the back link) on the user interface 100, the web server 210 can determine the category related to the product and can send data instructing the web browser to display popup window 700 to inform the user that there is at least one other product in this category that the user may desire to view. Popup window 700 can display information related to the unviewed product, as well as “Take Me There” button 720, a “Not Interested” button 722, and a “Stop Giving Me These Notices” button 724.

While the configuration from FIG. 7 illustrates displaying a popup window to indicate unviewed data, this is a nonlimiting example. More specifically, in at least an embodiment, the web server 210 can send an indication that the next page displayed includes the unviewed data. Other configurations can include compiling a plurality of products related to the 5232 Supershare home telephone 106 for display in a subsequently viewed web page. Additionally, other configurations can provide that the current web page be amended to include similar data. As a nonlimiting example, after a predetermined time of the user hovering a cursor over the home telephone 106 (FIG. 1), the web page can replace the other items on the page with products corresponding to the telephone category.

One should note that while the above description discusses a situation where the user has hovered a mouse cursor over a displayed product, this is a nonlimiting example. More specifically, in at least an embodiment, the web server 210 can be configured to compile a plurality of data associated with user actions and take into consideration any of that information in determining the desired information to display. More specifically, as a user may accidentally hover a mouse cursor over a certain displayed product, the user may not desire to view Supershare telephones. Depending on the particular situation, any of a plurality of different data can be utilized in determining the data to display.

Additionally, while the above description relates to a desired product to display, other aspects of a displayed web page can be customized based on the collected user actions data. More specifically, in at least an embodiment, if the web server determines that the user prefers a certain color for a web page (possibly based on the amount of time the user spends at various web pages and/or other data), the web page can accommodate the user's preference by displaying that particular color for that particular user.

FIG. 8 is a flowchart illustrating an embodiment of steps that can be taken in synchronously communicating data between a web server and a web browser, similar to the sequence diagram from FIG. 5. The first step in this nonlimiting example is for the web browser 390 to receive a user request for web page data (block 830). As discussed above, a user can input a URL or otherwise indicate to the web browser 390 that the user desires to view a particular website. Once the web browser 390 receives the user input, the web browser 390 can send a request to the web server 210 (block 832). Depending on the particular configuration, this request can be made via a JavaScript engine 388, but this is not a requirement. Upon receiving the request, the web server 210 can process the request and send the requested data to the web browser 390 (block 834). The web browser 390 can then display the web page 386. The web browser 390 can then gather information related to user actions (block 838) and send the collected data to the web server 210 (block 840). The web server 210 can then document the actions for subsequent display (block 842).

FIG. 9 is a flowchart illustrating an embodiment of steps that can be taken in asynchronously communicating data between a web server and a web browser, similar to the flowchart from FIG. 8. The first step in this nonlimiting example is for the web browser 390 to receive a user request for web page data (block 930). Next, the web browser 390 sends a request to the JavaScript engine 388 (block 932). The JavaScript engine 388 can then process the request and send a processed request to the web server 210 (block 934). The web server 210 can then process the request and send requested data back to the JavaScript engine 388 (block 936). The JavaScript engine 388 can process the JavaScript received from the web server 210 and send HTML data to the web browser 390 (block 938). The web browser 390 can then receive data related to the user actions (block 940). Upon receiving the data related to user actions, the web browser can asynchronously send data related to the user actions to the web server 210 (block 942). As discussed above, the web browser 390 can send the data via the JavaScript engine 388. Next, upon receiving data related to the user actions, the web server 210 sends data to the web browser to customize the data presented (block 944). Again, the data can be sent via the JavaScript engine 388, which can process XML and JavaScript and provide formatted data to the web browser 390 for display. Although not shown in FIGS. 8 and 9, it should be appreciated that the web server may be configured to communicate with a data store to provide data.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for providing customization via information feedback, the method comprising:
receiving data related to at least one user action on a web page, the at least one user action being indicative of user interest related to at least one item displayed on the web page;
determining a category related to the at least one item; and
sending data related to at least one other item, the at least one other item being related to the determined category.

2. The method of claim 1, wherein the at least one user action includes at least one of the following: hovering a cursor over the at least one item, selecting text associated with the at least one item, highlighting the at least one item, and arranging the at least one item in a viewable portion of the web page.

3. The method of claim 1, wherein the data related to the at least one user action is received asynchronously.

4. The method of claim 1, wherein the data related to the at least one user action is received synchronously.

5. The method of claim 1, wherein the data related to the at least one user action is received from a web browser.

6. The method of claim 1, wherein the data related to the at least one user action is received from a JavaScript engine.

7. The method of claim 1, wherein the data related to at least one other item is configured for display on the web page.

8. A computer readable medium for providing customization via information feedback, the computer readable medium comprising:
logic configured to receive data related to at least one user action on a web page, the at least one user action being indicative of user interest related to at least one item displayed on the web page;
logic configured to determine a category related to the at least one item; and
logic configured to send data related to at least one other item, the at least one other item being related to the determined category.

9. The computer readable medium of claim 8, wherein the at least one user action includes at least one of the following: hovering a cursor over the at least one item, selecting text associated with the at least one item, highlighting the at least one item, and arranging the at least one item in a viewable portion of the web page.

10. The computer readable medium of claim 8, wherein the data related to the at least one user action is received asynchronously.

11. The computer readable medium of claim 8, wherein the data related to the at least one user action is received synchronously.

12. The computer readable medium of claim 8, wherein the data related to the at least one user action is received from a web browser.

13. The computer readable medium of claim 8, wherein the data related to the at least one user action is received from a JavaScript engine.

14. The computer readable medium of claim 8, wherein the data related to at least one other item is configured for display on the web page.

15. A method for providing customization via information feedback, the method comprising:
receiving data related to at least one passive user action, the at least one passive user action related to at least one item on a web page;
determining at least one user interest from the at least one passive user action; and
sending data related to at least one other item, the at least one other item related to the determined user interest.

16. The method of claim 15, wherein the at least one passive user action includes at least one of the following: hovering a cursor over the at least one item, selecting text associated with the at least one item, highlighting the at least one item, and arranging the at least one item in a viewable portion of the web page.

17. The method of claim 15, wherein the data related to the at least one passive user action is received asynchronously.

18. The method of claim 15, wherein the data related to the at least one passive user action is received from a web browser.

19. The method of claim 15, wherein the data related to the at least one passive user action is received from a JavaScript engine.

20. The method of claim 15, wherein the data related to at least one other item is configured for display on a web page.
